(19) United States
(12) Patent Application Publication
(10) Pub. No.: US 2023/0406305 A1
(43) Pub. Date: Dec. 21, 2023

(54) METHODS AND SYSTEMS FOR COASTDOWN TEST WIND MEASUREMENT

(71) Applicant: GM GLOBAL TECHNOLOGY OPERATIONS LLC, Detroit, MI (US)

(72) Inventors: Nathan A. Wilmot, Novi, MI (US); Nick Brian Smith, Brighton, MI (US)

(73) Assignee: GM GLOBAL TECHNOLOGY OPERATIONS LLC, Detroit, MI (US)

(21) Appl. No.: 17/663,679

(22) Filed: May 17, 2022

(51) Int. Cl. B60W 30/18; G01M 17/007; B62D 63/04; B60W 10/04; B60W 10/18; B60W 10/20

(52) U.S. Cl. CPC B60W 30/18009; G01M 17/007; B62D 63/04; G01P 5/02; B60W 10/18; B60W 10/20; B60W 10/04

(57) ABSTRACT

A measurement vehicle for use with a vehicle under a coastdown test on a surface includes a chassis including one or more wheels, and a propulsion system coupled to the chassis. The propulsion system is configured to drive the one or more wheels to move the measurement vehicle relative to the vehicle. The measurement vehicle includes at least one sensor configured to observe one or more conditions associated with the coastdown test and a communication system configured to transmit the one or more conditions to the vehicle.

### INTRODUCTION

The technical field generally relates to methods and systems for test measurement, and more particularly relates to methods and systems for coastdown test wind measurement using a discrete measurement vehicle.

Generally, vehicles are subjected to tests to determine various vehicle performance parameters. For example, a vehicle may be subject to a coastdown test, in which the vehicle is accelerated to a high speed on a flat surface, and allowed to coast along the flat surface until the vehicle reaches a very low speed. The coastdown test is generally used to evaluate vehicle resistance to motion, and aerodynamic resistance or drag acting on the vehicle contributes to the vehicle resistance to motion. Generally, wind speed, temperature and direction measurements are needed to determine the aerodynamic resistance on the vehicle, which is used to correct the measured vehicle resistance to motion. Typically, a boom or arm having a wind sensor, or anemometer, is mounted to the vehicle under test. In certain instances, due to the design of the vehicle, it may be difficult to couple the boom to the vehicle. In addition, the boom itself may provide aerodynamic resistance, which may impact the aerodynamic resistance of the vehicle.

Accordingly, it is desirable to provide methods and systems for coastdown test wind measurement that do not require the use of a boom or arm being mounted to the vehicle, and which separates the wind sensor from the vehicle under test to improve aerodynamic resistance measurement accuracy. Furthermore, other desirable features and characteristics of the present invention will become apparent from the subsequent detailed description and the appended claims, taken in conjunction with the accompanying drawings and the foregoing technical field and background.

### SUMMARY

According to various embodiments, provided is a measurement vehicle for use with a vehicle under a coastdown test on a surface. The measurement vehicle includes a chassis including one or more wheels, and a propulsion system coupled to the chassis. The propulsion system is configured to drive the one or more wheels to move the measurement vehicle relative to the vehicle. The measurement vehicle includes at least one sensor configured to observe one or more conditions associated with the coastdown test and a communication system configured to transmit the one or more conditions to the vehicle.

The at least one sensor is an anemometer that observes a wind speed and a wind direction during the coastdown test, and the communication system is configured to transmit the wind speed and the wind direction to the vehicle. The at least one sensor is a velocity sensor that observes a velocity of the measurement vehicle during the coastdown test, and the communication system is configured to transmit the velocity of the measurement vehicle to the vehicle. The measurement vehicle includes a proximity sensor that is configured to observe a distance between the at least one sensor of the measurement vehicle and the vehicle, and a controller, having a processor, configured to determine a proximity of the at least one sensor of the measurement vehicle to the vehicle based on the distance and to output one or more control signals to the propulsion system based on the proximity. The processor of the controller is configured to retrieve a target distance value from a datastore, to compare the target distance value to the proximity and to output the one or more control signals to control an output of the propulsion system based on the comparison. The measurement vehicle includes a brake system configured to apply a braking force to at least one of the one or more wheels, and wherein the processor of the controller is configured to output one or more control signals to the brake system based on the comparison. The processor of the controller is configured to retrieve a target range from the datastore, to compare the proximity to the target range and to transmit an error message to the vehicle via the communication system that the proximity is outside of the target range. The measurement vehicle includes a path sensor that is configured to observe a path coupled to the surface, a steering actuator coupled to the one or more wheels and configured to rotate the one or more wheels to turn the measurement vehicle, and the processor of the controller is configured to determine whether the measurement vehicle is on the path and centered on the path, and to output one or more control signals to the steering actuator based on the determination. Based on the determination that the measurement vehicle is not on the path, the processor is configured to transmit an error message to the vehicle via the communication system.

Further provided is a method for measuring wind during a coastdown test of a vehicle on a surface. The method includes providing a measurement vehicle independent of the vehicle. The measurement vehicle includes a chassis with one or more wheels driven by a propulsion system. The method includes observing a wind speed and a wind direction with an anemometer coupled to the measurement vehicle, and controlling, by a processor associated with the measurement vehicle, a proximity of the anemometer to the vehicle during the coastdown test. The method includes communicating, by the processor associated with the measurement vehicle, the wind speed and the wind direction to the vehicle.

The method includes observing a velocity of the measurement vehicle with a velocity sensor coupled to the measurement vehicle, and communicating, by the processor associated with the measurement vehicle, the velocity of the measurement vehicle to the vehicle. The method includes observing a path coupled to the surface with a path sensor, determining, by the processor associated with the measurement vehicle, that the measurement vehicle is on the path, determining, by the processor associated with the measurement vehicle, whether the measurement vehicle is centered on the path, and outputting, by the processor associated with the measurement vehicle, one or more control signals to a steering actuator associated with the measurement vehicle based on the determining. The method includes determining that the measurement vehicle is not on the path, and outputting, by the processor associated with the measurement vehicle, an error message to the vehicle via a communication system associated with the measurement vehicle. The method includes retrieving, by the processor associated with the measurement vehicle, a target distance value from a target datastore, observing a distance between the anemometer of the measurement vehicle and the vehicle by a proximity sensor coupled to the measurement vehicle, determining, by the processor associated with the measurement vehicle, the proximity of the anemometer of the measurement vehicle to the vehicle based on the observed distance, and comparing, by the processor associated with the measurement vehicle, the target distance value and the proximity, and outputting one or more control signals to control an output of the propulsion system associated with the measurement vehicle based on the comparison.

Also provided is a measurement vehicle for use with a vehicle under a coastdown test on a surface. The measurement vehicle includes a chassis including one or more wheels, and a propulsion system coupled to the chassis. The propulsion system is configured to drive the one or more wheels to move the measurement vehicle relative to the vehicle. The measurement vehicle includes a power source in communication with the propulsion system, and an anemometer configured to observe a wind speed and a wind direction associated with the coastdown test. The measurement vehicle includes a velocity sensor configured to observe a velocity of the measurement vehicle, and a communication system configured to transmit the wind speed, the wind direction and the velocity to the vehicle. The measurement vehicle includes a proximity sensor configured to observe a distance between the anemometer and the vehicle. The measurement vehicle includes a controller, having a processor configured to: determine a proximity of the anemometer to the vehicle based on the distance, and output one or more control signals to control an output of the propulsion system based on the proximity of the anemometer to the vehicle.

The processor of the controller is configured to retrieve a target distance value from a datastore, to compare the proximity to the target distance value and to output the one or more control signals based on the comparison. The measurement vehicle includes a brake system configured to apply a braking force to at least one of the one or more wheels, and wherein the processor of the controller is configured to output one or more control signals to the brake system based on the comparison. The processor of the controller is configured to retrieve a target range from the datastore, to compare the proximity to the target range and to transmit an error message to the vehicle via the communication system that the proximity is outside of the target range. The measurement vehicle includes a path sensor that is configured to observe a path coupled to the surface, a steering actuator coupled to the one or more wheels and configured to rotate the one or more wheels to turn the measurement vehicle, and the processor of the controller is configured to determine whether the measurement vehicle is on the path and centered on the path, and to output one or more control signals to the steering actuator based on the determination. Based on a determination that the measurement vehicle is not on the path, the processor is configured to transmit an error message to the vehicle via the communication system.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic environmental illustration of an exemplary test vehicle and an exemplary measurement vehicle during a coastdown test;

FIG. 2 is a functional block diagram illustrating the measurement vehicle in accordance with various embodiments;

FIG. 3 is a schematic environmental illustration of the test vehicle and the measurement vehicle positioned on a flat road having a path in accordance with various embodiments;

FIG. 4 is a schematic environmental illustration of the test vehicle and the measurement vehicle positioned on another flat road having a path in accordance with various embodiments;

FIG. 5 is a dataflow diagram illustrating the wind measurement control system of the measurement vehicle of FIG. 2 in accordance with various embodiments; and

FIGS. 6A and 6B is a flowchart illustrating a control method performed by the wind measurement control system of the measurement vehicle of FIG. 2 in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure. As used herein, the term “about” denotes within 10%.

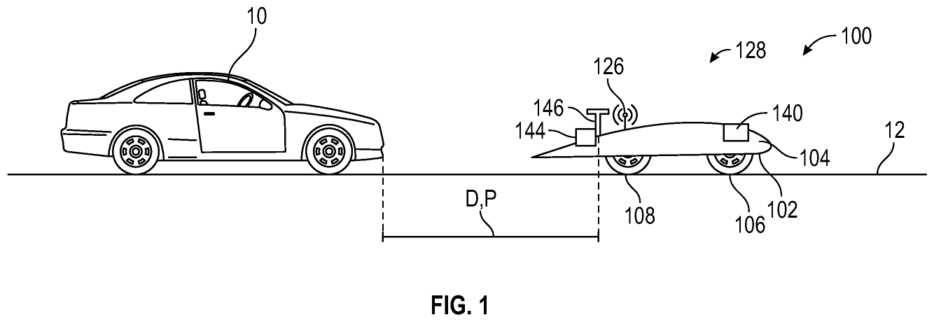

With reference to FIG. 1, a measurement vehicle shown generally as 100 is associated with a vehicle under test or test vehicle 10 in accordance with various embodiments. As will be discussed, the measurement vehicle 100 is controlled to maintain a wind sensor, such as an anemometer 146, a target distance D from the test vehicle 10 and to obtain wind speed and wind direction measurements as the test vehicle 10 performs a coastdown test on a substantially flat surface or road 12. In one example, the target distance D is about 2 meters (m). It should be noted that while the measurement vehicle 100 is described herein as being employed with a coastdown test, the measurement vehicle 100 may be employed with any test in which it is desired for measurements to be taken by a sensor remote from the test vehicle 10. Thus, the use of the anemometer 146 with the measurement vehicle 100 is merely an example. The test vehicle 10 generally comprises a passenger vehicle, including, but not limited to a passenger car, motorcycle, truck, van, sport utility vehicle (SUV), recreational vehicle (RV), etc. In addition, while the test vehicle 10 is depicted in FIG. 1 as a passenger car, it should be appreciated that any other vehicle, including motorcycles, trucks, vans, sport utility vehicles (SUVs), recreational vehicles (RVs), etc., can also be used. The test vehicle 10 generally includes a temperature sensor, which observes a temperature of the air surrounding the test vehicle 10.

As shown in FIG. 1, the measurement vehicle 100 is remote, discrete and uncoupled from the test vehicle 10. In one example, the measurement vehicle 100 includes a chassis 102, a body 104, and one or more wheels such as front wheels 106 and rear wheels 108. The body 104 is arranged on the chassis 102 and encloses various components of the measurement vehicle 100. In one example, the body 104 has a low profile, aerodynamic shape, such as a teardrop shape, to reduce aerodynamic resistance acting on the measurement vehicle 100. The body 104 may be composed of metal, metal alloy or polymer, and may be cast, forged, additively manufactured, etc. The body 104 and the chassis 102 may jointly form a frame. The wheels 106-108 are each rotationally coupled to the chassis 102 near a respective corner of the body 104.

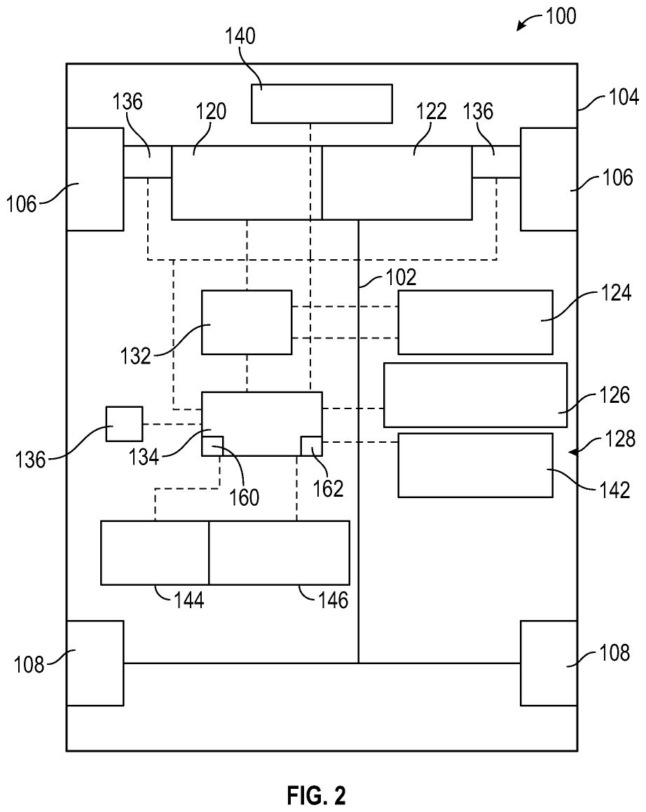

With additional reference to FIG. 2, a functional block diagram illustrates the various components of the measurement vehicle 100. In one example, the measurement vehicle 100 includes a propulsion system 120, a drivetrain 122, a steering actuator 124, a communication system 126, a sensor system 128, a brake system 130, a power source 132 and a controller 134 coupled to or supported by the frame. The measurement vehicle 100 may also include a human-machine interface 136. The propulsion system 120 may, in various embodiments, include an internal combustion engine or an electric machine, which is coupled to the chassis 102. In one example, the propulsion system 120 is an electric motor, which generates torque that is provided to the drivetrain 122 to drive the measurement vehicle 100 at speeds of at least 80 miles per hour (mph). Generally, the propulsion system 120 includes an output shaft, which is coupled to the drivetrain 122 to supply the drivetrain 122 with the torque generated by the propulsion system 120. The propulsion system 120 is also in communication with the controller 134 and the power source 132 to receive control signals and electrical energy over a suitable communication medium that facilitates the transfer of power, data, etc., including but not limited to a bus.

The drivetrain 122 is coupled to the propulsion system 120, and transmits the power generated by the propulsion system 120 to the wheels 106. In one example, the drivetrain 122 includes a gear box and at least one drive shaft. The gear box is coupled to the output shaft of the propulsion system 120 and receives the torque from the propulsion system 120 as input. The gear box reduces the torque received from the propulsion system 120 and uses this torque to drive at least one drive shaft coupled to the front wheels 106. It should be noted that in other examples, the drivetrain 122 may be configured differently to transmit power from the propulsion system 120 to the front wheels 106 and/or rear wheels 108.

The steering actuator 124 is in communication with the controller 134 and the power source 132 to receive control signals and electrical energy over a communication medium that supports the transfer of power, data, etc., including, but not limited to, a bus. In one example, the steering actuator 124 is also coupled to the front wheels 106. Generally, the steering actuator 124 is responsive to one or more control signals from the controller 134 to rotate the front wheels 106 to turn the measurement vehicle 100.

In one example, the communication system 126 is coupled to the measurement vehicle 100 on the body 104. It should be noted that in other examples, the communication system 126 may be coupled to the body 104 differently. The communication system 126 is in communication with the controller 134 over a communication medium that supports the transfer of power, data, etc., including but not limited to a bus. The communication system 126 is configured to wirelessly communicate information to and from other entities, such as but not limited to, other vehicles such as the test vehicle 10 (“V2V” communication), infrastructure (“V2I” communication), networks (“V2N” communication), pedestrian (“V2P” communication), remote transportation systems, and/or user devices. In an exemplary embodiment, the communication system 126 is a wireless communication system configured to communicate via a wireless local area network (WLAN) using IEEE 802.11 standards, by using cellular data communication. However, additional or alternate communication methods, such as a dedicated short-range communications (DSRC) channel or Bluetooth®, are also considered within the scope of the present disclosure. DSRC channels refer to one-way or two-way short-range to medium-range wireless communication channels specifically designed for automotive use and a corresponding set of protocols and standards. In this example, the communication system 126 includes at least a transmitter that broadcasts or communicates data from the sensor system 128 to the test vehicle 10 and/or a user device.

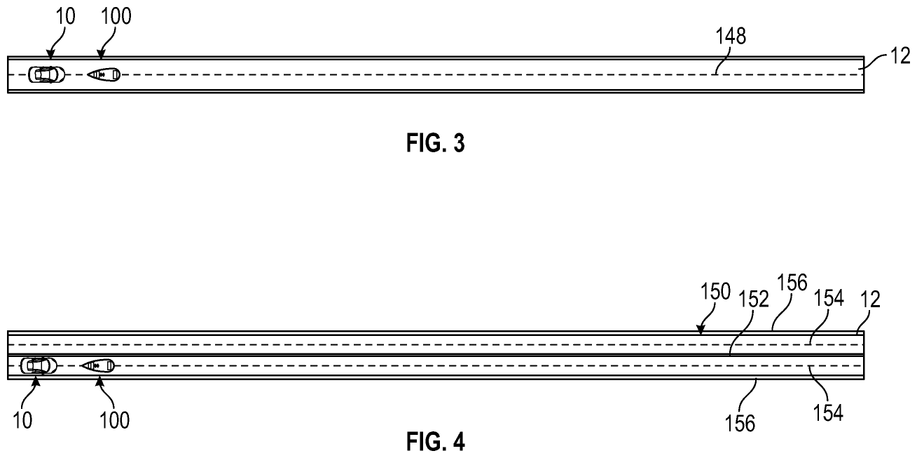

The sensor system 128 includes one or more sensing devices that sense observable conditions of the exterior environment of the measurement vehicle 100. The sensor system 128 is in communication with the controller 134 over a communication medium, including, but not limited to, a bus. In various embodiments, the sensing devices include, but are not limited to, a path sensor 140, a velocity sensor 142, a proximity sensor 144 and the anemometer 146. The path sensor 140 observes the flat road 12 and generates sensor signals based on the observation. In one example, with reference to FIG. 3, the flat road 12 includes a strip 148. The strip 148 defines a path for the measurement vehicle 100 to follow during the testing of the test vehicle 10. The strip 148 is coupled to the flat road 12 by embedding the strip 148 in the flat road 12, adhesives, paint, etc. In one example, the strip 148 is composed of a reflective material that is coupled to the flat road 12 via adhesives, such as an outdoor reflective tape, and the path sensor 140 is an optical sensor that observes the reflective tape and generates sensor signals based on the observed reflection. In another example, the strip 148 is composed of a metal or metal alloy, such as a thin sheet of steel or steel alloy, that is coupled to the flat road 12 by embedding the metallic material in the flat road 12. In the example of the strip 148 composed of a metal or metal alloy, the path sensor 140 is a magnetic sensor, such as an inductive sensor that observes the metal or metal alloy of the strip 148 and generates sensor signals based on the observed magnetic field.

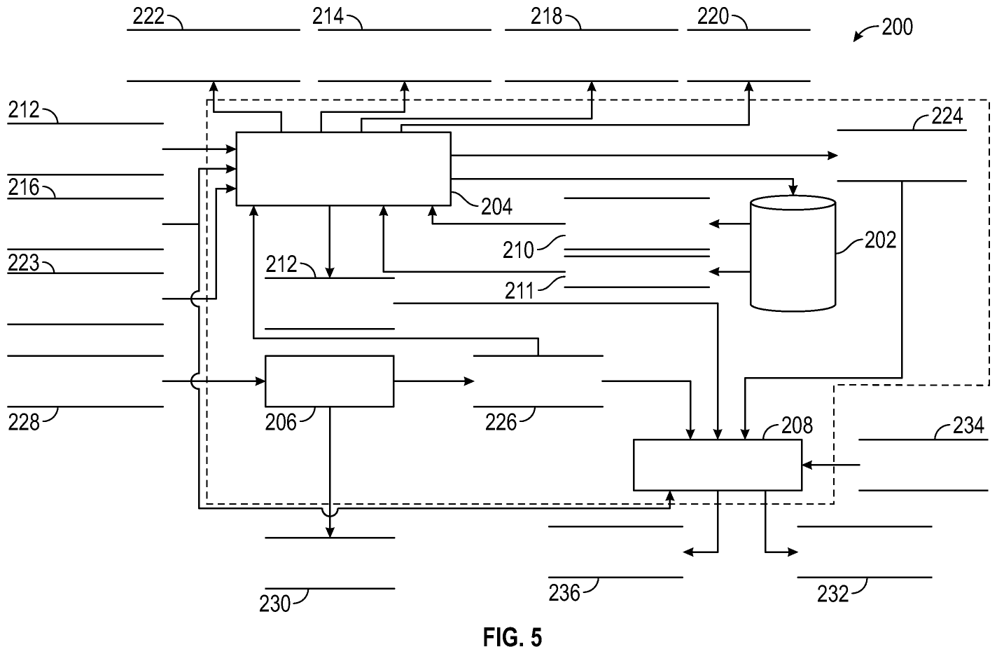

In other examples, with reference to FIG. 4, the flat road 12 may include lane markings 150. In this example, the lane markings 150 include a double yellow line 152, a pair of dashed white lines 154 and a solid white line 156. The lane markings 150 are coupled to the flat road 12 via painting. One of the pair of dashed white lines 154 defines the path for the measurement vehicle 100. In this example, the path sensor 140 is a camera, which observes the lane markings 150. The controller 134 processes the signals from the camera, and determines whether the measurement vehicle 100 is positioned along the path defined by the dashed white line 154.

With reference back to FIG. 2, the velocity sensor 142 observes a velocity of the measurement vehicle 100 and generates sensor signals based on the observation. The proximity sensor 144 observes the target distance D (FIG. 1) between the test vehicle 10 and the measurement vehicle 100 and generates sensor signals based on the observation. In one example, the proximity sensor 144 includes, but is not limited to, radars (e.g., long-range, medium-range-short range), lidars, sonars, lasers, optical cameras (e.g., forward facing, 360-degree, rear-facing, side-facing, stereo, etc.), thermal (e.g., infrared) cameras, ultrasonic sensors, and/or other sensors that observe a distance between the test vehicle 10 and the measurement vehicle 100. Generally, the proximity sensor 144 is a sensor that observes the distance between the test vehicle 10 and the anemometer 146 of the measurement vehicle 100, and generates sensor signals based on the observation. In this example, the proximity sensor 144 is adjacent to or along the side of the anemometer 146 such that the proximity sensor 144 observes the distance the anemometer 146 of the measurement vehicle 100 is spaced apart from the test vehicle 10. The anemometer 146 observes a wind speed and direction, and generates sensor signals based on the observation. In one example, the anemometer 146 is a rotating anemometer, which observes the wind speed and wind direction relative to the path of the test vehicle 10. It should be noted that the sensor system 128 may also include a temperature sensor, which may be used to measure a temperature of the ambient environment surrounding the measurement vehicle 100.

The brake system 130 is configured to provide braking torque to the wheels 106 and 108. Brake system 130 may, in various embodiments, include friction brakes, brake by wire and/or other appropriate braking systems. It should be noted that the brake system 130 is optional, as the speed of the measurement vehicle 100 may be controlled by controlling an output of the propulsion system 120, for example. If employed, the brake system 130 is in communication with the controller 134 and the power source 132 over a communication medium that facilitates the transfer of data, power, etc., including but not limited to, a bus.

The power source 132 is in communication with the controller 134, the propulsion system 120, the steering actuator 124 and the brake system 130 over a communication medium, including but not limited to, a bus. The power source 132 provides power to the propulsion system 120, the steering actuator 124 and the brake system 130. In one example, the power source 132 is a battery, which provides electrical energy to the propulsion system 120, the steering actuator 124 and the brake system 130. The power source 132 may also provide power or electrical energy to the sensor system 128, if needed. In one example, the power source 132 is a rechargeable battery. It should be noted, however, that other sources may be used to supply power or electrical energy to the propulsion system 120, the steering actuator 124, the brake system 130 and the sensor system 128. Further, in the example of the propulsion system 120 comprising an internal combustion engine, the power source 132 may also include a fuel tank and fuel supply system to supply fuel to the internal combustion engine.

In certain examples, the measurement vehicle 100 may include the human-machine interface 136. The human-machine interface 136 is in communication with the controller 134 via a suitable communication medium, such as a bus. The human-machine interface 136 may be configured in a variety of ways. In some embodiments, the human-machine interface 136 may include various buttons, switches, or levers, such as an on/off button, a microphone associated with a speech recognition system, or various other human-machine interface devices.

The controller 134 includes at least one processor 160 and a computer-readable storage device or media 162. The processor 160 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 134, a semiconductor-based microprocessor (in the form of a microchip or chip set), any combination thereof, or generally any device for executing instructions. The computer readable storage device or media 162 may include volatile and nonvolatile storage in read-only memory (ROM), random-access memory (RAM), and keep-alive memory (KAM), for example. KAM is a persistent or non-volatile memory that may be used to store various operating variables while the processor 160 is powered down. The computer-readable storage device or media 162 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 134 in controlling the measurement vehicle 100. In various embodiments, controller 134 is configured to implement instructions of the wind measurement control system 200 as discussed in detail below.

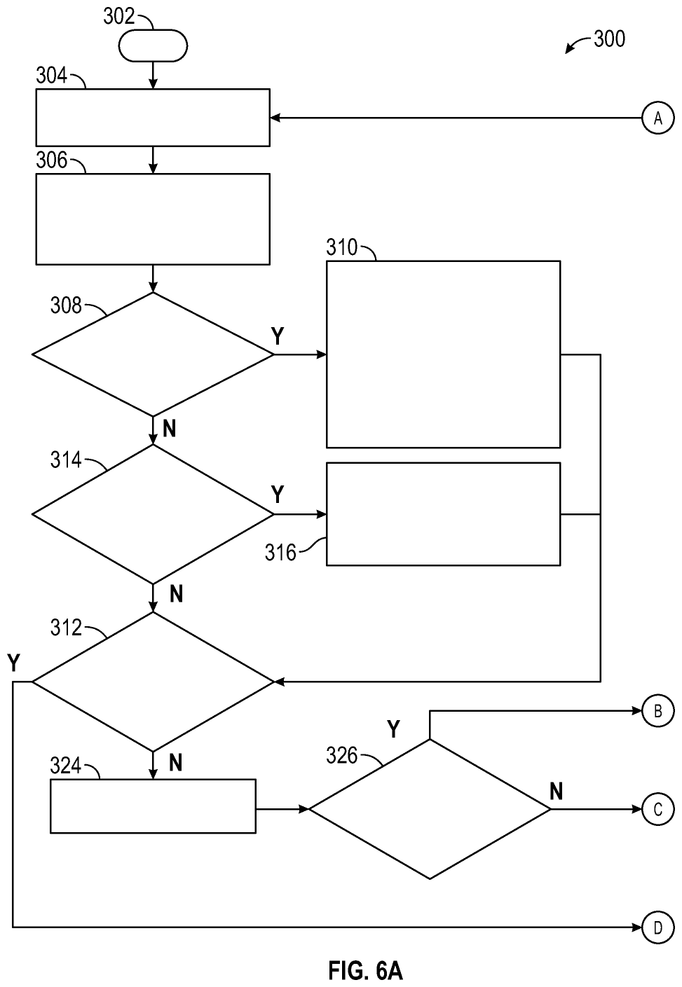

For example, as shown in more detail with regard to FIG. 5 and with continued reference to FIGS. 1 and 2, a dataflow diagram illustrates various embodiments of the wind measurement control system 200, which may be embedded within the controller 134. Various embodiments of the wind measurement control system 200 according to the present disclosure can include any number of sub-modules embedded within the controller 134. As can be appreciated, the sub-modules shown in FIG. 5 can be combined and/or further partitioned to control the measurement vehicle 100. Inputs to the wind measurement control system 200 may be received from the sensor system 128 (FIG. 2), received from the human-machine interface 136 (FIG. 2), received from other control modules (not shown) associated with the wind measurement control system 200, and/or determined/modeled by other sub-modules (not shown) within the controller 134. In various embodiments, the wind measurement control system 200 includes a target datastore 202, a propulsion system control module 204, a path monitor module 206, and a communication control module 208.

The target datastore 202 stores data of the target distance D or target distance value 210. In one example, the target distance value 210 is the target distance D, which is about 2 meters (m). The target distance value 210 is a predefined or predetermined value. The target datastore 202 also stores a target range 211. The target range 211 is an acceptable range of values for a proximity of the anemometer 146 of the measurement vehicle 100 to the test vehicle 10. In one example, the target range 211 is about 1 meter (m) to about 3 meters (m). Generally, a proximity of the anemometer 146 of the measurement vehicle 100 to the test vehicle 10 beyond or outside of the target range 211 would result in the need to restart the coastdown test. The target range 211 is a predefined or predetermined range of values.

The propulsion system control module 204 receives as input velocity sensor data 212. The velocity sensor data 212 is data from the velocity sensor 142, which includes the observed speed of the measurement vehicle 100. Based on the velocity sensor data 212, the propulsion system control module 204 determines whether the measurement vehicle 100 has a velocity of about zero such that the measurement vehicle 100 is about stationary. If the velocity of the measurement vehicle 100 is about zero, such that the measurement vehicle 100 is about stationary, the propulsion system control module 204 outputs propulsion system stop data 214. The propulsion system stop data 214 is one or more control signals to the power source 132 to cease the supply of power to the propulsion system 120 so that the propulsion system stops. The propulsion system control module 204 also sets the velocity sensor data 212 for the communication control module 208.

The propulsion system control module 204 also receives input data 223. The input data 223 is data from the human-machine interface 136 that indicates to start or stop a coastdown test. Based on the input data 223, the propulsion system control module 204 receives as input proximity sensor data 216. The proximity sensor data 216 is the data from the proximity sensor 144, which includes the observed distance between the test vehicle 10 and the anemometer 146 of the measurement vehicle 100. The propulsion system control module 204 interprets the proximity sensor data 216 and determines a proximity of the anemometer 146 of the measurement vehicle 100 to the test vehicle 10. The proximity of the anemometer 146 of the measurement vehicle 100 to the test vehicle is the distance labeled P in FIG. 1. In the example of FIG. 1, the proximity sensor 144 is positioned at the anemometer 146 such that the distance observed by the proximity sensor 144 is the same as the proximity P the anemometer 146 is spaced apart from the test vehicle 10. In other embodiments, the proximity sensor 144 may be spaced a predetermined distance from the anemometer 146 such that the propulsion system control module 204 adds a predefined value to the distance observed by the proximity sensor 144 to determine the proximity P of the anemometer 146 to the test vehicle 10.

Based on the proximity sensor data 216, the propulsion system control module 204 retrieves the target distance value 210 and the target range 211 from the target datastore 202. The propulsion system control module 204 compares the proximity of the anemometer 146 of the measurement vehicle 100 to the test vehicle 10 to the target distance value 210. If the proximity of the anemometer 146 of the measurement vehicle 100 to the test vehicle 10 is greater than the target distance value 210, the propulsion system control module 204 outputs propulsion system slow control data 218. The propulsion system slow control data 218 is one or more control signals to the power source 132 to decrease a voltage supplied to the propulsion system 120 in the example of the propulsion system 120 as an electric machine, so that the output of the propulsion system 120 decreases, which in turn, decreases a speed of the measurement vehicle 100. Thus, generally, the propulsion system control module 204 controls the power source 132 to decrease the speed of the propulsion system 120, and thus, the measurement vehicle 100, when the proximity of the anemometer 146 of the measurement vehicle 100 to the test vehicle 10 is greater than the target distance D. Alternatively, or in addition, the propulsion system control module 204 outputs brake control data 220. The brake control data 220 is one or more control signals to the brake system 130 to actuate the brakes to slow the measurement vehicle 100.

If the proximity of the anemometer 146 of the measurement vehicle 100 to the test vehicle 10 is less than the target distance value 210, the propulsion system control module 204 outputs propulsion system control data 222. The propulsion system control data 222 is one or more control signals to the power source 132 to increase a voltage supplied to the propulsion system 120 in the example of the propulsion system 120 as an electric machine, so that the output of the propulsion system 120 increases, which in turn, increases a speed of the measurement vehicle 100. Thus, generally, the propulsion system control module 204 controls the power source 132 to increase the speed of the propulsion system 120, and thus, the measurement vehicle 100, when the proximity of the anemometer 146 of the measurement vehicle 100 to the test vehicle 10 is less than the target distance D.

The propulsion system control module 204 compares the proximity of the anemometer 146 of the measurement vehicle 100 to the test vehicle 10 to the target range 211. If the proximity of the anemometer 146 of the measurement vehicle 100 to the test vehicle 10 is outside of the target range 211 or is not within the target range 211, the propulsion system control module 204 outputs propulsion system stop data 214. The propulsion system control module 204 also sets target error data 224 for the communication control module 208. The target error data 224 is data that indicates that the anemometer 146 of the measurement vehicle 100 is outside of the target range 211 and that the coastdown test is to be stopped.

The propulsion system control module 204 also receives as input path error data 226. The path error data 226 is data that indicates that the measurement vehicle 100 is off the path such that the coastdown test is to be stopped. Based on the path error data 226, the propulsion system control module 204 outputs the propulsion system stop data 214.

The path monitor module 206 receives as input path sensor data 228. The path sensor data 228 is data from the path sensor 140, which includes the observations of the path associated with the flat road 12. In the example of the path sensor 140 as an optical sensor, the path sensor data 228 includes observations of the reflective tape. In the example of the path sensor 140 as a magnetic sensor, the path sensor data 228 includes observations of the magnetic field. In the example of the path sensor 140 as a camera, the path sensor data 228 includes observations of the lane markings 150. The path monitor module 206 interprets the path sensor data 228 and determines whether the path is identified in the path sensor data 228. For example, the path monitor module 206 determines whether the optical sensor observes the reflective tape. In the example of the path sensor 140 as a magnetic sensor, the path monitor module 206 interprets the data from the path sensor 140 and determines whether the magnetic field indicates that the measurement vehicle 100 is on the path. In the example of the path sensor 140 as a camera, the path monitor module 206 interprets the data from the path sensor 140 and determines whether the dashed white line 154 is observed, which indicates that the measurement vehicle 100 is on the path. If the path monitor module 206 determines that the measurement vehicle 100 is not on the path based on the path sensor data 228, the path monitor module 206 sets the path error data 226 for the propulsion system control module 204 and the communication control module 208.

If the propulsion system control module 204 determines the measurement vehicle 100 is on the path from the path sensor data 228, the path monitor module 206 determines whether the measurement vehicle 100 is centered on the path. In the example of the optical sensor, the path monitor module 206 determines whether the measurement vehicle 100 is centered on the path based on the intensity of the reflections observed. In the example of the magnetic sensor, the path monitor module 206 determines whether the measurement vehicle 100 is centered on the path based on the intensity of the magnetic field observed. In the example of the camera, the path monitor module 206 determines whether the measurement vehicle 100 is centered on the path based on the image data using Hough transform and Canny edge detector techniques, for example. It should be noted that various other techniques may be used to determine the position of the measurement vehicle 100 on the flat road 12 when the path sensor 140 is a camera. Based on the determination that the measurement vehicle 100 is not centered on the flat road 12, the path monitor module 206 outputs steering control data 230. The steering control data 230 is data of one or more control signals to the steering actuator 124 to turn the wheels 106 to steer the measurement vehicle 100 to stay on the path.

The communication control module 208 receives as input the path error data 226. Based on the path error data 226, the communication control module 208 outputs measurement vehicle data 232 for the test vehicle 10. The measurement vehicle data 232 is data that provides an error message that the measurement vehicle 100 is stopping due to an error associated with the measurement vehicle 100. The communication control module 208 also receives as input the target error data 224. Based on the target error data 224, the communication control module 208 also outputs the measurement vehicle data 232. The communication control module 208 receives as input the velocity sensor data 212, the proximity sensor data 216 and receives as input anemometer data 234. The anemometer data 234 is data from the anemometer 146, which includes the wind speed and wind direction observed. The communication control module 208 outputs the velocity sensor data 212, the proximity sensor data 216 and the anemometer data 234 as measurement data 236 to the test vehicle 10. In one example, the communication control module 208 may also time stamp the measurement data 236 such that the measurement data 236 includes the time of day, the velocity of the measurement vehicle 100 observed by the velocity sensor 142, the observed distance between the test vehicle 10 and the anemometer 146 of the measurement vehicle 100 and the wind speed and wind direction observed by the anemometer 146. In other examples, the test vehicle 10 may timestamp the measurement data 236 when received from the measurement vehicle 100. It should be noted that in other embodiments, the measurement vehicle 100 may include a data storage device configured to store the measurement data 236 and to be accessed by a user device to download the measurement data 236 upon completion of the coastdown test. In addition, it should be noted that the inclusion of the proximity sensor data 216 with the measurement data 236 may be optional.

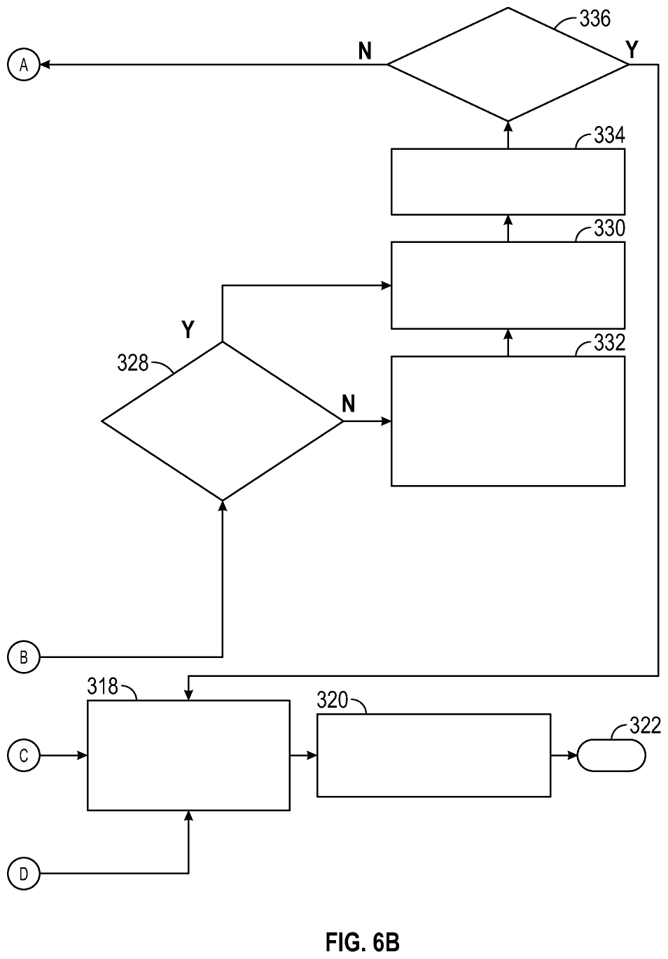

Referring now to FIGS. 6A and 6B, and with continued reference to FIGS. 1, 2 and a flowchart illustrates a control method 300 that can be performed by wind measurement control system 200 of FIG. 1 in accordance with the present disclosure. In one example, the control method 300 is performed by the processor 160 of the controller 134. As can be appreciated in light of the disclosure, the order of operation within the method is not limited to the sequential execution as illustrated in FIGS. 6A and 6B, but may be performed in one or more varying orders as applicable and in accordance with the present disclosure. In various embodiments, the control method 300 is initiated by receipt of an input to the human-machine interface 136.

The method begins at 302. At 304, the method receives the proximity sensor data 216 from the proximity sensor 144. At 306, the method interprets the proximity sensor data 216 and determines the proximity of the anemometer 146 of the measurement vehicle 100 to the test vehicle 10. At 308, the method retrieves the target distance value 210 and the target range 211. The method determines whether the proximity of the anemometer 146 of the measurement vehicle 100 to the test vehicle 10 is greater than the target distance value 210. If true, the method proceeds to 310. At 310, the method outputs one or more control signals to decrease the propulsion system output or outputs the propulsion system slow control data 218. Optionally, the method outputs one or more control signals to the brake system 130 to actuate the brakes to reduce the speed of the measurement vehicle 100 or outputs the brake control data 220. The method proceeds to 312.

If at 308 the method determines the proximity of the anemometer 146 of the measurement vehicle 100 is not greater than the target distance value 210, the method determines, at 314, whether the proximity of the anemometer 146 of the measurement vehicle 100 is less than the target distance value 210. If true, the method proceeds to 316. At 316, the method outputs one or more control signals to increase the propulsion system output or outputs the propulsion system control data 222. The method proceeds to 312.

At 312, the method determines whether the proximity of the anemometer 146 of the measurement vehicle 100 is outside of the target range 211. If true, the method proceeds to 318. At 318, the method outputs one or more control signals to the propulsion system 120 to stop or outputs the propulsion system stop data 214. At 320, the method outputs the error message to the test vehicle 10 or the measurement vehicle data 232. The method ends at 322.

If the proximity of the anemometer 146 of the measurement vehicle 100 is within the target range 211, the method proceeds to 324. At 324, the method receives the path sensor data 228 from the path sensor 140. At 326, the method interprets the path sensor data 228 and determines whether the measurement vehicle 100 is on the path. If false, the method proceeds to 318. Otherwise, if the measurement vehicle 100 is on the path, at 328, the method determines whether the measurement vehicle 100 is centered on the path based on the path sensor data 228. If true, the method proceeds to 330. Otherwise, at 332, the method outputs one or more control signals to the steering actuator 124 to center the measurement vehicle 100 on the path or outputs the steering control data 230.

At 330, the method receives the anemometer data 234 and the velocity sensor data 212. At 334, the method outputs the measurement data 236, including the anemometer data 234, the proximity sensor data 216 and the velocity sensor data 212, to the test vehicle At 336, the method interprets the velocity sensor data 212 and determines whether the velocity of the measurement vehicle 100 is about zero, such that the measurement vehicle 100 is about stationary, based on the velocity sensor data 212. If false, the method proceeds to 304. Otherwise, if true, the method proceeds to 318.

Thus, the measurement vehicle 100 facilitates the measurement of the wind speed and direction of the test vehicle 10 while being independent from the test vehicle 10. By providing the measurement vehicle 100 separate and discrete from the test vehicle 10, the test vehicle 10 is not required to be modified to accommodate a boom that supports an anemometer, for example. In addition, by providing the measurement vehicle 100 independent from the test vehicle 10, an accuracy of the aerodynamic resistance acting on the test vehicle 10 during a coastdown test may be improved. Generally, based on the wind speed measured by the anemometer 146 and the velocity of the measurement vehicle 100, the test vehicle 10 may determine the wind speed acting on the test vehicle 10. The wind speed acting on the test vehicle 10 may be used in turn to determine the aerodynamic resistance of the test vehicle 10. In addition, if the sensor system 128 includes a temperature sensor or the test vehicle 10 includes the temperature sensor, the aerodynamic resistance value may be adjusted based on the temperature to account for air density affects.

It should be noted that while the measurement vehicle 100 is described herein as being controlled by the controller 134, in other embodiments, the measurement vehicle 100 may be controlled by a remote device, such as a user device, which provides control signals to the controller 134 via the communication system 126. In addition, it should be noted that while the measurement vehicle 100 is described and illustrated herein as comprising a wheeled vehicle, in other embodiments, the measurement vehicle 100 may be configured differently to measure wind speed and direction. For example, the measurement vehicle 100 may be configured as a drone or other flying object that is controlled by a controller or user device to position an anemometer a target distance from the test vehicle 10. In addition, in other embodiments, the measurement vehicle 100 may be responsive to signals received from the test vehicle 10, for example, to maintain a position in front of the test vehicle 10 during the coastdown test.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A measurement vehicle for use with a vehicle under a coastdown test on a surface, comprising:
a chassis including one or more wheels;
a propulsion system coupled to the chassis, the propulsion system configured to drive the one or more wheels to move the measurement vehicle relative to the vehicle;
at least one sensor configured to observe one or more conditions associated with the coastdown test; and
a communication system configured to transmit the one or more conditions to the vehicle.

2. The measurement vehicle of claim 1, wherein the at least one sensor is an anemometer that observes a wind speed and a wind direction during the coastdown test, and the communication system is configured to transmit the wind speed and the wind direction to the vehicle.

3. The measurement vehicle of claim 1, wherein the at least one sensor is a velocity sensor that observes a velocity of the measurement vehicle during the coastdown test, and the communication system is configured to transmit the velocity of the measurement vehicle to the vehicle.

4. The measurement vehicle of claim 1, further comprising a proximity sensor that is configured to observe a distance between the at least one sensor of the measurement vehicle and the vehicle, and a controller, having a processor, configured to determine a proximity of the at least one sensor of the measurement vehicle to the vehicle based on the distance and to output one or more control signals to the propulsion system based on the proximity.

5. The measurement vehicle of claim 4, wherein the processor of the controller is configured to retrieve a target distance value from a datastore, to compare the target distance value to the proximity and to output the one or more control signals to control an output of the propulsion system based on the comparison.

6. The measurement vehicle of claim 5, further comprising a brake system configured to apply a braking force to at least one of the one or more wheels, and wherein the processor of the controller is configured to output one or more control signals to the brake system based on the comparison.

7. The measurement vehicle of claim 5, wherein the processor of the controller is configured to retrieve a target range from the datastore, to compare the proximity to the target range and to transmit an error message to the vehicle via the communication system that the proximity is outside of the target range.

8. The measurement vehicle of claim 4, further comprising a path sensor that is configured to observe a path coupled to the surface, a steering actuator coupled to the one or more wheels and configured to rotate the one or more wheels to turn the measurement vehicle, and the processor of the controller is configured to determine whether the measurement vehicle is on the path and centered on the path, and to output one or more control signals to the steering actuator based on the determination.

9. The measurement vehicle of claim 8, wherein based on the determination that the measurement vehicle is not on the path, the processor is configured to transmit an error message to the vehicle via the communication system.

10. A method for measuring wind during a coastdown test of a vehicle on a surface, comprising:
providing a measurement vehicle independent of the vehicle, the measurement vehicle including a chassis with one or more wheels driven by a propulsion system;
observing a wind speed and a wind direction with an anemometer coupled to the measurement vehicle;
controlling, by a processor associated with the measurement vehicle, a proximity of the anemometer to the vehicle during the coastdown test; and
communicating, by the processor associated with the measurement vehicle, the wind speed and the wind direction to the vehicle.

11. The method of claim 10, further comprising:
observing a velocity of the measurement vehicle with a velocity sensor coupled to the measurement vehicle; and
communicating, by the processor associated with the measurement vehicle, the velocity of the measurement vehicle to the vehicle.

12. The method of claim 10, further comprising:
observing a path coupled to the surface with a path sensor;
determining, by the processor associated with the measurement vehicle, that the measurement vehicle is on the path;
determining, by the processor associated with the measurement vehicle, whether the measurement vehicle is centered on the path; and
outputting, by the processor associated with the measurement vehicle, one or more control signals to a steering actuator associated with the measurement vehicle based on the determining.

13. The method of claim 12, further comprising:
determining that the measurement vehicle is not on the path; and
outputting, by the processor associated with the measurement vehicle, an error message to the vehicle via a communication system associated with the measurement vehicle.

14. The method of claim 10, further comprising:
retrieving, by the processor associated with the measurement vehicle, a target distance value from a target datastore;
observing a distance between the anemometer of the measurement vehicle and the vehicle by a proximity sensor coupled to the measurement vehicle;
determining, by the processor associated with the measurement vehicle, the proximity of the anemometer of the measurement vehicle to the vehicle based on the observed distance; and
comparing, by the processor associated with the measurement vehicle, the target distance value and the proximity, and outputting one or more control signals to control an output of the propulsion system associated with the measurement vehicle based on the comparison.

15. A measurement vehicle for use with a vehicle under a coastdown test on a surface, comprising:
a chassis including one or more wheels;
a propulsion system coupled to the chassis, the propulsion system configured to drive the one or more wheels to move the measurement vehicle relative to the vehicle;
a power source in communication with the propulsion system;
an anemometer configured to observe a wind speed and a wind direction associated with the coastdown test;
a velocity sensor configured to observe a velocity of the measurement vehicle;
a communication system configured to transmit the wind speed, the wind direction and the velocity to the vehicle;
a proximity sensor configured to observe a distance between the anemometer and the vehicle;
a controller, having a processor configured to:
determine a proximity of the anemometer to the vehicle based on the distance; and
output one or more control signals to control an output of the propulsion system based on the proximity of the anemometer to the vehicle.

16. The measurement vehicle of claim 15, wherein the processor of the controller is configured to retrieve a target distance value from a datastore, to compare the proximity to the target distance value and to output the one or more control signals based on the comparison.

17. The measurement vehicle of claim 16, further comprising a brake system configured to apply a braking force to at least one of the one or more wheels, and wherein the processor of the controller is configured to output one or more control signals to the brake system based on the comparison.

18. The measurement vehicle of claim 16, wherein the processor of the controller is configured to retrieve a target range from the datastore, to compare the proximity to the target range and to transmit an error message to the vehicle via the communication system that the proximity is outside of the target range.

19. The measurement vehicle of claim 15, further comprising a path sensor that is configured to observe a path coupled to the surface, a steering actuator coupled to the one or more wheels and configured to rotate the one or more wheels to turn the measurement vehicle, and the processor of the controller is configured to determine whether the measurement vehicle is on the path and centered on the path, and to output one or more control signals to the steering actuator based on the determination.

20. The measurement vehicle of claim 19, wherein based on a determination that the measurement vehicle is not on the path, the processor is configured to transmit an error message to the vehicle via the communication system.
